(19) United States
(12) Patent Application Publication
(10) Pub. No.: US 2011/0021252 A1
(43) Pub. Date: Jan. 27, 2011

(54) PORTABLE COMMUNICATION APPARATUS WITH A USER MODE SWITCHING FUNCTION

(75) Inventor: KIM-YEUNG SIP, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISON INDUSTRY CO., LTD., Tu-Cheng (TW)

(21) Appl. No.: 12/548,445

(22) Filed: Aug. 27, 2009

(30) Foreign Application Priority Data
Jul. 23, 2009 (CN) 200910304761.5

(51) Int. Cl. H04M 1/00

(52) U.S. Cl. 455/566; 455/550.1

(57) ABSTRACT

A method for switching user modes of a communication apparatus is provided. The method comprises: controlling an angle sensor periodically to detect an angle of inclination of the communication apparatus, determining which range the detected angle of inclination is within; determining an associated user mode of the determined range; determining whether the user mode of the determined range is the same as a current user mode; enabling the associated audio receiving unit and audio output unit of the user mode of the determined range and disabling the associated audio receiving unit and audio output unit of the current user mode if the user mode of the determined range is not the same as the current user mode.

### BACKGROUND

1. Technical Field

The present disclosure relates to a portable communication apparatus with a user mode switching function.

2. Description of Related Art

Communication apparatuses, such as cell phones, with full touch screens are popular, but because of their symmetrical designs it is difficult to determine the current orientation of the devices. This results in users attempting to use their phones in an upside down orientation.

### BRIEF DESCRIPTION OF THE DRAWINGS

The components of the drawings are not necessarily drawn to scale, the emphasis instead being placed upon clearly illustrating the principles of the communication apparatus. Moreover, in the drawings, like reference numerals designate corresponding parts throughout several views.

FIG. 1 is a block diagram of a portable communication apparatus with a user mode switching function in accordance with an exemplary embodiment.

FIG. 2 is a position schematic diagram of audio receiving units and audio output units of the apparatus of FIG. 1 in accordance with an exemplary embodiment.

FIG. 3 is schematic diagram of the apparatus after rotating 180°.

FIG. 4 is a flowchart for switching a user mode of the apparatus of FIG. 1, in accordance with an exemplary embodiment.

### DETAILED DESCRIPTION

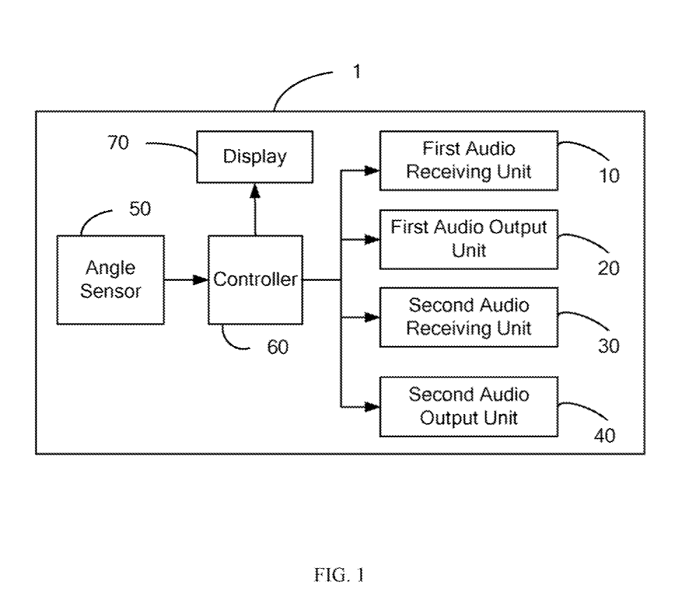

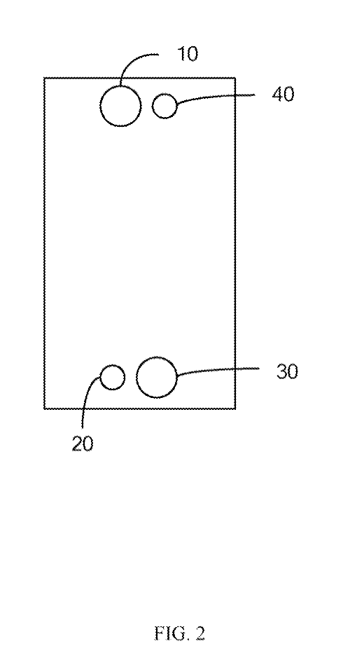

FIG. 1 is a block diagram of a portable communication apparatus 1 with a user mode switching function (hereinafter “the apparatus”) in accordance with an exemplary embodiment. The switching function allows a user to pick up and hold the apparatus 1 in any one of orientations, and a graphical user interface (GUI) and input/output devices will automatically change to suit the orientation so that the user need not worry about which is the correct way to hold the apparatus 1. The apparatus 1 includes at least two audio receiving units and at least two audio output units. In this exemplary embodiment, two audio receiving units, namely a first audio receiving unit 10 and a second receiving unit 30, and two audio output units, namely a first audio output unit 20 and a second audio output unit 40, are given as an example. Referring also to FIG. 2, the first audio receiving unit 10 and the second audio output unit 40 are positioned near one end of the apparatus 1, and the second audio receiving unit 20 and the first audio output unit 30 are positioned near an opposite end of the same side of the apparatus.

The apparatus 1 further includes an angle sensor 50 and a controller 60. The angle sensor 50 is configured for sensing an angle of inclination of the apparatus 1. The angle of inclination of the apparatus 1 is divided into at least two ranges. Each range is associated with one user mode. Each user mode is associated with one audio receiving unit and one audio output unit. The controller 60 is configured for controlling the angle sensor 50 to periodically detect the angle of inclination of the apparatus 1, determining which range the detected angle is within, and further determining the associated user mode of the determined range. After the user mode of the determined range is determined, the controller 60 determines whether the user mode of the determined range is the same as a current user mode. If the user mode of the determined range is not the same as the current user mode, the controller 60 enables the associated audio receiving unit and audio output unit of the user mode of the determined range, and disables the associated audio receiving unit and audio output unit of the current user mode.

In this exemplary embodiment, the first audio receiving unit 10 and the first audio output unit 20 are associated with a top-end up user mode. The associated range of the top-end up user mode is 0°˜180°. The second audio receiving unit 30 and the second audio output unit 40 are associated with a bottom-end up user mode. The associated range of the bottom-end up user mode is 0°˜180°. In the present embodiment, the associated range of the top-end up user mode is inclusive the two ends, the associated range of the bottom-end up user mode is exclusive the two ends. In another exemplary embodiment, the associated range of the top-end up user mode is exclusive the two ends, the associated range of the bottom-end up user mode is inclusive the two ends.

Supposing the current user mode of the apparatus 1 is top-end up user mode, when the angle of inclination detected by the angle sensor 50 is −180°, the controller 60 determines the associated range of this angle is −90˜180° and the associated user mode of the determined range is bottom-end up user mode. Therefore, the controller 60 enables the second audio receiving unit 30 and the second audio output unit 40, and disables the first audio receiving unit 10 and the first audio output unit 20.

Additionally, each user mode is associated with one user interface. When it is determined that the user mode of the determined range is not the same as the current user mode, the controller 60 controls a display 70 of the apparatus 1 to display the user interface of the user mode of the determined range.

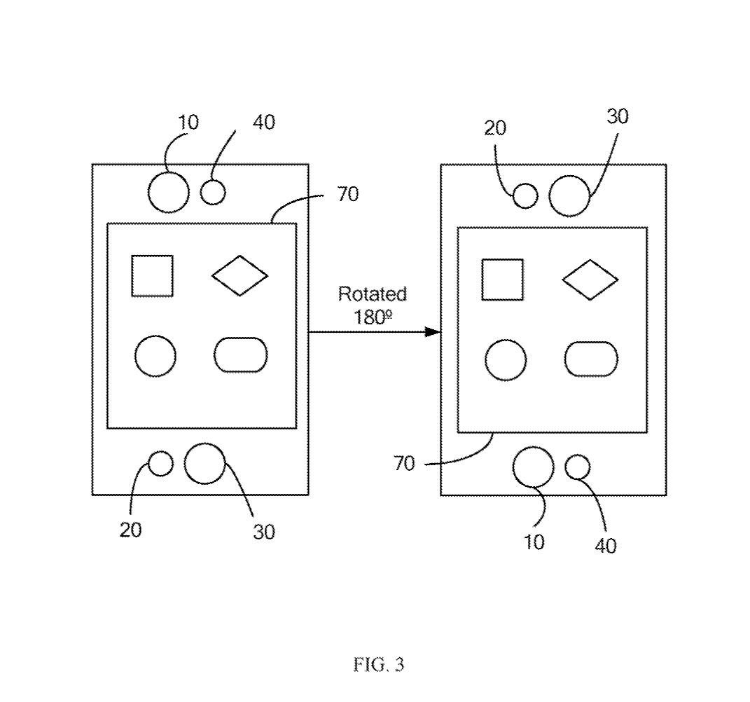

In this exemplary embodiment, the user interface of the bottom-end up user mode is similar to a user interface of the top-end up user mode except that it is rotated 180°, as shown in FIG. 3.

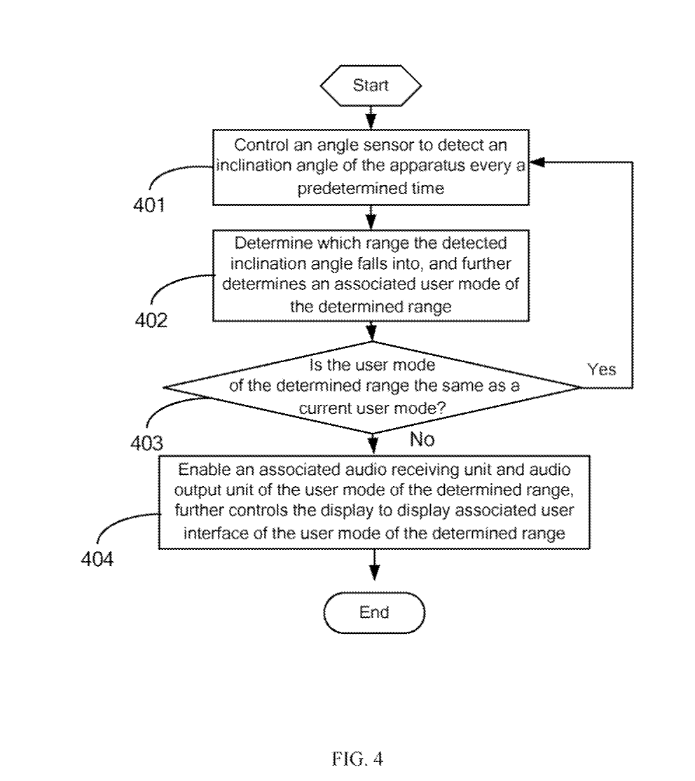

FIG. 4 is a flowchart of a method for switching the user mode of the apparatus of FIG. 1.

In step S401, the controller 60 controls the angle sensor 50 periodically to detect the angle of inclination of the apparatus 1.

In step S402, the controller 60 determines which range the detected angle of inclination is within, and further determines the associated user mode of the determined range.

In step S403, after the user mode of the determined range is determined, the controller 60 determines whether the user mode of the determined range is the same as a current user mode.

In step S404, if the user mode of the determined range is not the same as the current user mode, the controller 60 enables the associated audio receiving unit and audio output unit of the user mode of the determined range, and disables the associated audio receiving unit and audio output unit of the current user mode, further controls the display 70 to display associated user interface of the user mode of the determined range.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A portable communication apparatus with a user mode switching function, comprising at least two audio receiving units, at least two output units, an angle sensor, and a controller, the angle sensor being for sensing an angle of inclination of the apparatus, the angle of inclination of the apparatus being divided into at least two ranges, each range being associated with one user mode, each user mode being associated with one audio receiving unit and one audio output unit, the controller being for controlling the angle sensor to periodically detect the angle of inclination of the apparatus, determining which range the detected angle of inclination is within, and further determining the associated user mode of the determined range, after the user mode of the determined range is determined, the controller determining whether the user mode of the determined range being the same as a current user mode, if the user mode of the determined range is not the same as the current user mode, the controller enabling the associated audio receiving unit and audio output unit of the user mode of the determined range, and disabling the associated audio receiving unit and audio output unit of the current user mode.

2. The communication apparatus as described in claim 1, wherein each user mode associates with one user interface, when determined that the user mode of the determined range is not the same as the current user mode, the controller controls a display of the apparatus to display the user interface of the user mode of the determined range.

3. The communication apparatus as described in claim 1, wherein the communication apparatus comprises an top-end up user mode and a bottom-end user mode, the top-end up user mode associates a first audio receiving unit and a first audio output unit, the bottom-end up user mode associates with a second audio receiving unit and a second audio output unit, the first audio receiving unit and the second audio output unit are positioned in near one end of the apparatus, and the second audio receiving unit and the first audio output unit are positioned in opposite end of the same side of the apparatus.

4. The communication apparatus as described in claim 3, wherein the top-end up user mode associated with a first user interface, and a bottom-end up user mode associated with a second user interface, the first user interface is similar to the second user interface except that it is rotated 180°

5. A method for switching user modes of a communication apparatus, comprising:
providing at least two audio receiving units, at least two output units;
controlling an angle sensor periodically to detect an angle of inclination of the communication apparatus, the angle of inclination of the apparatus being divided into at least two ranges, each range being associated with one user mode, each user mode being associated with one audio receiving unit and one audio output unit;
determining which range the detected angle of inclination is within;
determining an associated user mode of the determined range;
determining whether the user mode of the determined range is the same as a current user mode;
enabling the associated audio receiving unit and audio output unit of the user mode of the determined range and disabling the associated audio receiving unit and audio output unit of the current user mode if the user mode of the determined range is not the same as the current user mode.

6. The method as described in claim 5, wherein each user mode associates with one user interface, the method further comprises controlling a display of the apparatus to display a user interface of the user mode of the determined range when determined that the user mode of the determined range is not the same as the current user mode, the controller.
